(19) United States
(12) Patent Application Publication
(10) Pub. No.: US 2025/0190626 A1
(43) Pub. Date: Jun. 12, 2025

(54) METHOD, APPARATUS, AND ELECTRONIC DEVICE FOR INTERACTIVE PUBLICATION OF AN INTERFACE BASED ON A PERMISSION

(71) Applicant: Beijing Youzhuju Network Technology Co., Ltd., Beijing (CN)

(72) Inventor: Zishuo Liu, Beijing (CN)

(21) Appl. No.: 18/842,026

(22) PCT Filed: Feb. 8, 2023
(86) PCT No.: PCT/CN2023/075057

§ 371 Date: Aug. 27, 2024

(30) Foreign Application Priority Data
Feb. 28, 2022 (CN) 202210187940.0

(51) Int. Cl. G06F 21/62; G06F 9/451

(52) U.S. Cl. CPC G06F 21/629; G06F 9/451

(57) ABSTRACT

Provided method, apparatus, electronic device, computer readable storage medium, computer program product, and computer program for interactive publication of an interface based on a permission, displaying first interface information in an interactive page corresponding to a first user permission, the first interface information indicating at least one to-be-processed interface which is an application programming interface processed based on the first user permission; configuring a to-be-processed target interface to be in a target state in response to a first operation instruction for the to-be-processed target interface, the first operation instruction is realized based on the first user permission; under a predetermined triggering condition, according to a target state of the to-be-processed target interface, publishing the to-be-processed target interface to an open platform, or generating second interface information corresponding to the to-be-processed target interface, which is used for displaying to-be-processed target interface in an interactive page corresponding to a second user permission.

### CROSS REFERENCE TO RELATED APPLICATIONS

This application claims priority to Chinese Patent Application No. 202210187940.0, filed on Feb. 28, 2022, and entitled METHOD, APPARATUS, AND ELECTRONIC DEVICE FOR INTERACTIVE PUBLICATION OF AN INTERFACE BASED ON A PERMISSION, which is incorporated herein by reference in its entirety.

### FIELD

Embodiments of the present disclosure relate to the field of Internet technologies, and in particular, to a method, an apparatus, an electronic device, a computer readable storage medium, a computer program product, and a computer program for interactive publication of an interface based on a permission.

### BACKGROUND

An open platform refers to a software system that enables an external program to use its function or resource by exposing application programming interface (API) without changing source codes. In an Internet application scenario, an open platform is generally used to encapsulate a website service into a series of interfaces (APIs) and open the interfaces to other developers for use, that is, interface publishing (Open API).

In the prior art, during developing and publishing an interface by a service provider, a function service and a corresponding program code of an open interface are usually manually written by a developer, and the program code is output to a subsequent auditor, then a corresponding code check is made by the auditor to ensure that relevant parameters of the interface are correct and secure, and finally be published to an open platform.

The interface publishing scheme in the prior art causes the problems of long time consumption and low efficiency in the management process before publishing an interface.

### SUMMARY

Embodiments of the present disclosure provide a method, an apparatus, an electronic device, a computer readable storage medium, a computer program product, and a computer program for interactive publication of an interface based on a permission.

According to a first aspect, an embodiment of the present disclosure provides a method for interactive publication of an interface based on a permission, comprising:
displaying first interface information in an interactive page corresponding to a first user permission, the first interface information indicating at least one to-be-processed interface, and the to-be-processed interface being an application programming interface processed based on the first user permission; configuring a to-be-processed target interface to be in a target state in response to a first operation instruction for the to-be-processed target interface, wherein the first operation instruction is realized based on the first user permission; and under a predetermined triggering condition, according to a target state of the to-be-processed target interface, publishing the to-be-processed target interface to an open platform, or generating second interface information corresponding to the to-be-processed target interface, the second interface information being used for displaying the to-be-processed target interface in an interactive page corresponding to a second user permission.

According to a second aspect, an embodiment of the present disclosure provides an apparatus for interactive publication of an interface based on a permission, comprising:
a display module configured to display first interface information in an interactive page corresponding to a first user permission, the first interface information indicating at least one to-be-processed interface, and the to-be-processed interface being an application programming interface processed based on the first user permission;
a configuration module configured to configure a to-be-processed target interface to be in a target state in response to a first operation instruction for the to-be-processed target interface, wherein the first operation instruction is realized based on the first user permission; and
a publication module configured to, under a predetermined triggering condition, according to a target state of the to-be-processed target interface, publish the to-be-processed target interface to an open platform, or generate second interface information corresponding to the to-be-processed target interface, the second interface information being used for displaying the to-be-processed target interface in an interactive page corresponding to a second user permission.

According to a third aspect, an embodiment of the present disclosure provides an electronic device, comprising:
a processor, and a memory communicatively connected with the processor;
the memory storing computer executable instructions which, when executed by the processor, implement the method for interactive publication of an interface based on a permission of the first aspect and its various possible designs.

According to a fourth aspect, an embodiment of the present disclosure provides a computer readable storage medium, wherein the computer readable storage medium stores computer executable instructions which, when executed by a processor, implement the method for interactive publication of an interface based on a permission of the first aspect and its various possible designs.

According to a fifth aspect, an embodiment of the present disclosure provides a computer program product comprising a computer program which, when executed by a processor, implements the method for interactive publication of an interface based on a permission of the first aspect and its various possible designs.

According to a sixth aspect, an embodiment of the present disclosure provides a computer program, when executed by a processor, implementing the method for interactive publication of an interface based on a permission of the first aspect and its various possible designs.

Embodiments of the present disclosure provide a method, an apparatus, an electronic device, a computer readable storage medium, a computer program product, and a computer program for interactive publication of an interface based on a permission, comprising: displaying first interface information in an interactive page corresponding to a first user permission, the first interface information indicating at least one to-be-processed interface, and the to-be-processed interface being an application programming interface processed based on the first user permission; configuring a to-be-processed target interface to be in a target state in response to a first operation instruction for the to-be-processed target interface, wherein the first operation instruction is realized based on the first user permission; and under a predetermined triggering condition, according to a target state of the to-be-processed target interface, publishing the to-be-processed target interface to an open platform, or generating second interface information corresponding to the to-be-processed target interface, the second interface information being used for displaying the to-be-processed target interface in an interactive page corresponding to a second user permission.

### BRIEF DESCRIPTION OF THE DRAWINGS

To describe the technical solutions in the embodiments of the present disclosure or the related technologies more clearly, the following briefly introduces the accompanying drawings required for describing the embodiments or the related technologies. Apparently, the accompanying drawings in the following description show some embodiments of the present disclosure, other drawings may also be obtained according to these drawings without creative efforts.

FIG. 1 is an application scenario diagram of a method for interactive publication of an interface based on a permission according to an embodiment of the present disclosure.

FIG. 2 is a first schematic flowchart of a method for interactive publication of an interface based on a permission according to an embodiment of the present disclosure.

FIG. 3 is a schematic diagram of an interactive interface according to an embodiment of the present disclosure.

FIG. 4 is a schematic diagram of another interactive interface according to an embodiment of the present disclosure.

FIG. 5 is a schematic diagram of a workflow of interface publication according to an embodiment of the present disclosure.

FIG. 6 is a second schematic flowchart of a method for interactive publication of an interface based on a permission according to an embodiment of the present disclosure.

FIG. 7 is a schematic diagram of generating first interface information through a configuration page according to an embodiment of the present disclosure.

FIG. 8 is a flowchart of specific implementation of step S203 in the embodiment shown in FIG. 6.

FIG. 9 is a flowchart of specific implementation of step S207 of the embodiment shown in FIG. 6.

FIG. 10 is a third flowchart of a method for interactive publication of an interface based on a permission according to an embodiment of the present disclosure.

FIG. 11 is a structural block diagram of an apparatus for interactive publication of an interface based on a permission according to an embodiment of the present disclosure.

FIG. 12 is a schematic structure diagram of an electronic device according to an embodiment of the present disclosure.

FIG. 13 is a schematic structural diagram of hardware of an electronic device according to an embodiment of the present disclosure.

### DETAILED DESCRIPTION

In order to make objects, technical solutions and advantages of the embodiments of the present disclosure more apparent, the technical solutions in the embodiments of the present disclosure will be clearly and fully described below in connection with the drawings related to the embodiments of the present disclosure. Obviously, the described embodiments are only a part but not all of the embodiments of the present disclosure. All other embodiments obtained by persons of ordinary skill in the art based on the embodiments of the present disclosure without creative efforts shall belong to the protection scope of the present disclosure.

Application scenarios of the embodiments of the present disclosure will be explained below:

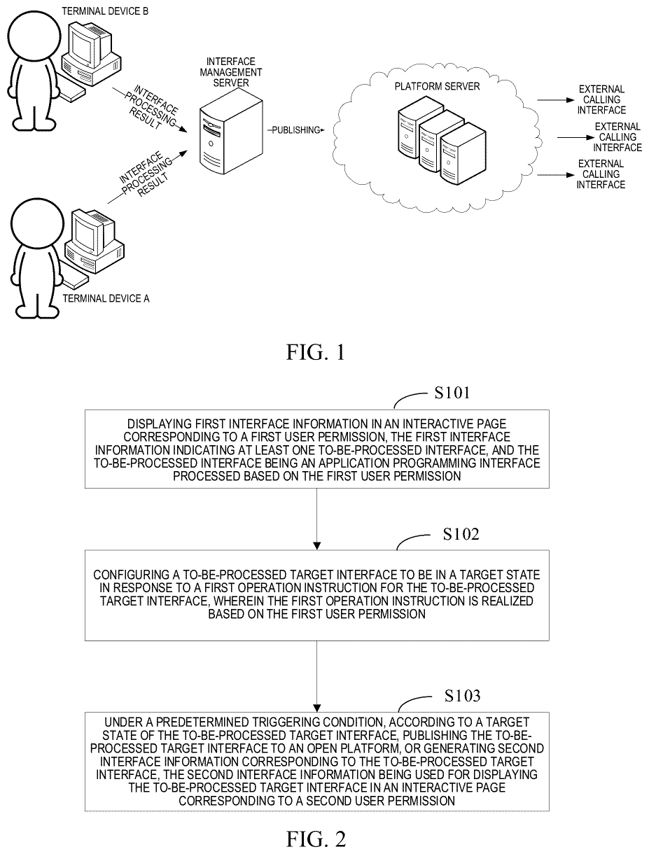

FIG. 1 is an application scenario diagram of a method for interactive publication of an interface based on a permission provided in an embodiment of the present disclosure. The method for interactive publication of an interface based on a permission provided in the embodiment of the present disclosure may be applied to an application scenario of publishing an open interface. Specifically, as shown in FIG. 1, the method provided in the embodiment of the present disclosure may be applied to a terminal device. The terminal device is communicatively connected with an interface management server, and the interface management server is communicatively connected with a platform server running an open platform, or the interface management server is used for running the open platform at the same time. A client program (Client) runs on the side of terminal device, such as client software or a browser, and a server program (Server) runs on the side of the interface management server. The interface developer uses the terminal devices with different permissions (such as terminal device A and terminal device B shown in FIG. 1) to process the interfaces by the method for interactive publication of an interface based on a permission provided in the embodiments of this disclosure, and synchronize a processing result to an interface management server, to realize the management of open interfaces. Then, the interface management server publishes the processed open interfaces to the open platform. An external developer may obtain the open interfaces by accessing an open platform running in a platform server.

In the prior art, during developing and publishing an interface by a service provider, a function service and a corresponding program code of an open interface are usually manually written by a developer. Especially for a large-scale software system, there are many developers responsible for interface development, and each developer is responsible for development and maintenance of several interfaces. Meanwhile, the open platform enables external third-party software and websites to use service resources and service functions provided by a service provider through an open interface. As for the service resources of the open platform, it needs to be allocated in a business dimension. More specifically, for example, some function interfaces are limited, so as to prevent an external user (an external application) from occupying too many system resources due to excessive access. As another example, some functional interfaces are opened only to some external users (external applications). Based on the above reasons, before an interface is published, specific parameters of an interface developed by a developer need an auditor with a higher level and a higher permission to review, in order to ensure that the parameters of the interface is correct and secure, and then the interface is published to an open platform.

However, in the prior art, after a function service and a corresponding program code of an open interface are manually written by a developer, they are only be output to a subsequent auditor in a form of program code, and then the reviewed by an auditor accordingly, thereby ensuring that relevant parameters of the interface are correct and secure. Due to the difference in habits and styles of the program code written by the developer, the auditor has problems of long time consumption in the audit process and poor real-time response in the process of auditing by means of code checking, and further has problems of long time consumption and low efficiency in the management process before publishing the open interface.

Embodiments of the present disclosure provide a method, apparatus, and electronic device for interactive publication of an interface based on a permission, so as to solve the foregoing problem.

Referring to FIG. 2, it is a first schematic flowchart of a method for interactive publication of an interface based on a permission according to an embodiment of the present disclosure. The method in this embodiment may be applied to a terminal device, and the method for interactive publication of an interface based on a permission includes:

Step S101: displaying first interface information in an interactive page corresponding to a first user permission, the first interface information indicating at least one to-be-processed interface, and the to-be-processed interface being an application programming interface processed based on the first user permission.

For example, the interactive page is a man-machine interactive interface of a user end (for example, a browser) running in the terminal device. After being started, the user end running in the terminal device displays a corresponding login interface. A user inputs login information, such as a user name and a password, on the login interface and logs in, then a corresponding interactive interface may be displayed. For example, different login information corresponds to different user permissions, and different permissions correspond to different interactive interfaces. For example, after login with the user name A, the user permission corresponding to the user name A is the first user permission, and the user is correspondingly logged into the interactive page #1; after login with the user name B, the user permission corresponding to the user name B is the second user permission, and the user is correspondingly logged in to the interactive page #2. Therefore, after the first user permission is obtained according to the login information, the corresponding interactive page may be logged in based on a predetermined mapping relationship between user permission and interactive pages. A specific implementation of obtaining a user permission according to login information is a prior art known to a person skilled in the art, and is not described herein again.

It should be noted that, in a possible implementation, different login information may correspond to a same user permission. For example, a user name A, a user name B, and a user name C all correspond to a first user permission. Therefore, when login with the user name A, the user name B, and the user name C, a same interactive interface #1 may be logged in. However, in another possible implementation, login information and user permission may be in one-to-one correspondence, for example, one user name corresponds to one user permission. Thus, when each user logs in, a corresponding accurately divided user permission is obtained, and then corresponding information is displayed in a login page.

Further, the first interface information is displayed in a predetermined area of interactive page, wherein the first interface information indicates an application programming interface (API) processed based on a first user permission is the to-be-processed interface. Specifically, for example, the first interface information comprises an interface identifier. A for different user permissions, after the interactive interface is logged in, the displayed first interface information may be different. For example, after the interactive page #1 is logged in based on the first user permission, the displayed first interface information includes three to-be-processed interfaces, i.e., interface A, interface B and interface C. After the interactive page #1 is logged in based on the second user permission, the displayed first interface information includes three to-be-processed interfaces, i.e., interface D, interface E and interface F. That is, for different user permissions, the corresponding interactive pages may be the same, but the corresponding first interface information is different. In a specific application scenario, different interaction information may correspond to different developers and auditors, so that after login, the interfaces for which they are responsible are displayed in an interactive page.

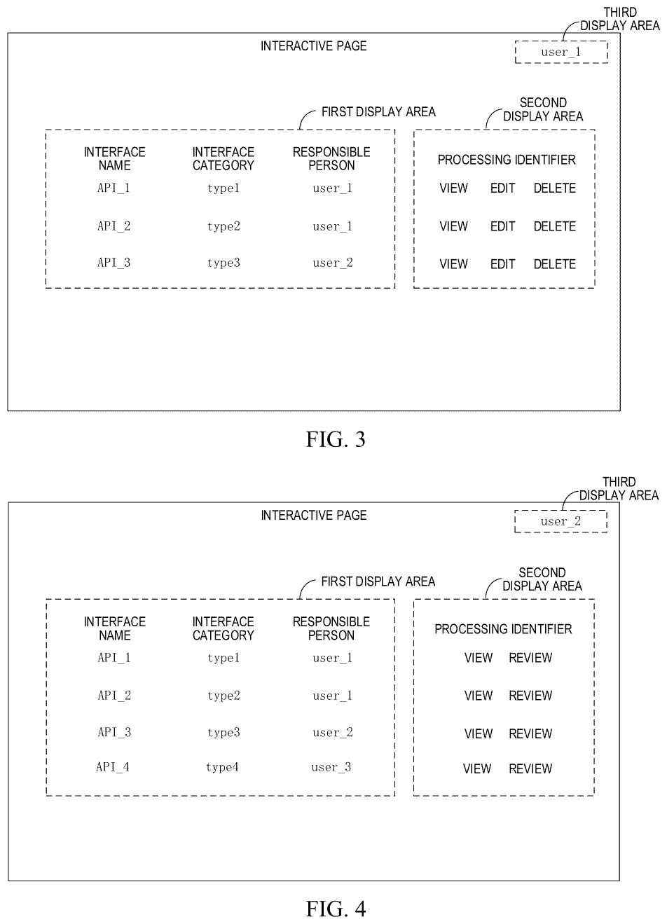

FIG. 3 is a schematic diagram of an interactive interface according to an embodiment of the present disclosure. As shown in FIG. 3, first interface information is displayed in a first display area in the interactive interface. Specifically, the first interface information includes interface names (API_1, API_2, and API_3), corresponding interface categories (type 1, type 2, and type 3), and responsible persons (user_1, user_1, and user_2). Optionally, in a second display area in the interactive interface, a processing identifier (for example, view, edit, delete, and the like shown in the figure) corresponding to each interface is further included, so as to edit the foregoing to-be-processed interfaces. Optionally, in a third display area in the interactive interface, login information corresponding to the first user permission is further displayed, that is, a user name (shown as user_1 in the figure).

Step S102: configuring a to-be-processed target interface to be in a target state in response to a first operation instruction for the to-be-processed target interface, wherein the first operation instruction is realized based on the first user permission.

For example, after the interactive interface is displayed, several to-be-processed interfaces are displayed to the user by first interface information in the interactive interface. Then, the user performs a first operation on the to-be-processed target interface according to needs, to enable the terminal device to obtain a corresponding first operation instruction. Then, in response to the first operation instruction, the terminal device processes the to-be-processed target interface, so as to change the state of the to-be-processed target interface, configuring same to be in a target state, in which the process is equivalent to a processing and management process for a to-be-processed target interface.

For example, FIG. 4 is a schematic diagram of another interactive interface according to an embodiment of the present disclosure. As shown in FIG. 4, a second interface information is displayed in a first display area of the interactive interface, and specifically, including an interface name (API_1, API_2, API_3, and API_4), a corresponding interface category (type 1, type 2, type 3, and type 4), and a responsible person (user_1, user_1, user_2, and user_3). In a second display area of the interactive interface, a processing identifier (such as view and review shown in the figure) corresponding to each interface is further included, so as to review the foregoing to-be-processed interfaces. A third display area of the interactive interface further displays login information corresponding to the first user permission, that is, a user name (shown as user_2 in the figure). With reference to the schematic diagrams of the interactive interface shown in FIGS. 3 and 4, when logged in with different login information, the first interface information changes accordingly, and the processing identifier used for operating the to-be-processed interface also changes accordingly. For example, a first operation instruction in a step of this embodiment is an operation instruction for a processing identifier corresponding to a to-be-processed interface, and more specifically, the first operation instruction is, for example, an instruction generated after an operation control corresponding to the processing identifier is triggered. When the user permission changes, the processing identifier changes accordingly, and therefore, the first operation instruction is realized based on the first user permission.

Specifically, the first operation instruction may be an interface editing instruction or an interface reviewing instruction, and the interface editing instruction or the interface reviewing instruction is realized based on different user permission. On one hand, an interface editing instruction is used for editing and modifying a to-be-processed target interface. After responding to the interface edit instruction, a terminal device modifies the relevant configuration information of the to-be-processed target interface, thereby achieving the purpose of modifying the to-be-processed target interface. On the other hand, the interface reviewing instruction is used for reviewing a to-be-processed target interface. Specifically, after responding to the interface reviewing instruction, the terminal device displays related configuration information of the to-be-processed target interface, thereby achieving the objective of user reviewing.

After the process of processing the to-be-processed target interface based on the first operation instruction is completed, it is equivalent to that the process of editing or reviewing the to-be-processed target interface has been completed, the to-be-processed target interface is configured to be in the corresponding target state. Specifically, the target state includes a publication state or a to-be-reviewed state. When the first operation instruction is used for editing the to-be-processed target interface, the to-be-processed target interface is configured to be in a to-be-reviewed state; and when the first operation instruction is used for reviewing the to-be-processed target interface, the to-be-processed target interface is configured to be in the to-be-published state.

In the steps of this embodiment, the to-be-processed target interface is configured to be in the target state, which is equivalent to marking the working state of the to-be-processed target interface, different target states correspond to different working states (e.g., a to-be-reviewed state and a to-be-published state) of the to-be-processed interface. The first operation instruction is realized based on the first user permission, to mark a working state of a to-be-processed target interface, then, the to-be-processed target interface flows to a corresponding workflow (review and publish) based on the marking (target state). Thus, the automatic and quick processing of the to-be-processed target interface is realized, and the efficiency of managing the to-be-processed target interface is improved.

Step S103: under a predetermined triggering condition, according to a target state of the to-be-processed target interface, publishing the to-be-processed target interface to an open platform, or generating second interface information corresponding to the to-be-processed target interface, the second interface information being used for displaying the to-be-processed target interface in an interactive page corresponding to a second user permission.

For example, after the target state of the to-be-processed target interface is obtained, the to-be-processed target interface is automatically processed based on the target state of the to-be-processed target interface, thereby implementing pushing of a publication task of the to-be-processed target interface.

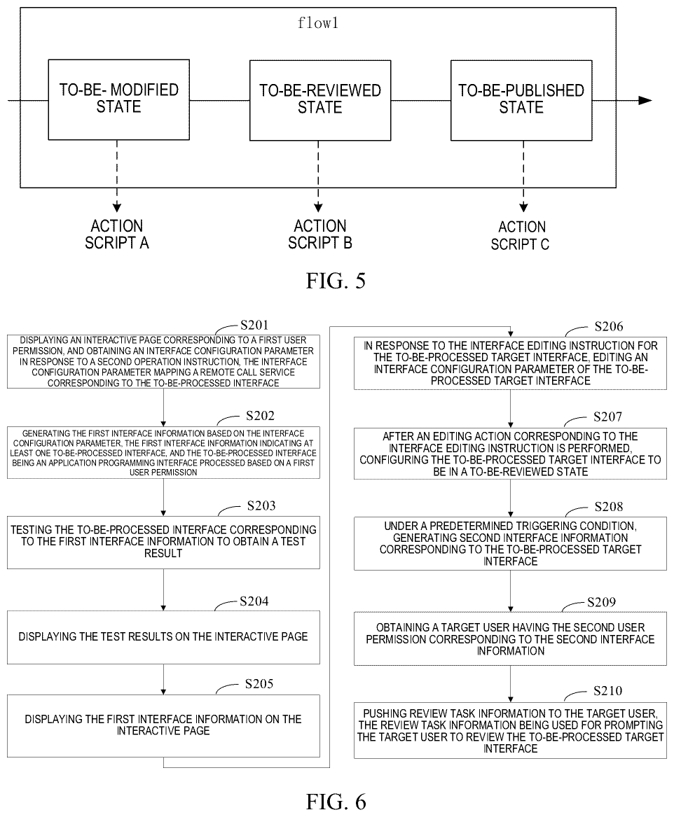

An interface publication task is implemented based on a predetermined workflow. FIG. 5 is a chematic diagram of a workflow of interface publication according to an embodiment of the present disclosure. As shown in FIG. 5, in the workflow flow 1, several working states (namely, nodes in the workflow) including a to-be-modified state, a to-be-reviewed state and a to-be-publication state are included. Each working state corresponds to one action script (action script A, action script B, action script C). The target state obtained in the foregoing step is information that represents a current working state of a to-be-processed node. Referring to FIG. 5, the target state may correspond to any one of a to-be-modified state, a to-be-reviewed state, and a to-be-published state. The workflow information representing the realization of the workflow is stored in the terminal device, and the terminal device may determine the current working state of the to-be-processed target interface according to the workflow information and the target state of the to-be-processed target interface, and then execute the corresponding action script. Specifically, a to-be-processed target interface is published to an open platform, or second interface information corresponding to the to-be-processed target interface is generated. The above process may be implemented by the terminal device through the interface management server. That is, the terminal device synchronizes the to-be-processed target interface and the target state to the interface management server, publishes, through an interface management server, a to-be-processed target interface to an open platform, or generates, through the interface management server, second interface information corresponding to the to-be-processed target interface.

When the target state is a to-be-published state, the to-be-processed target interface is published to the open platform; when the target state is a to-be-reviewed state, second interface information corresponding to the to-be-processed interface target is generated, wherein the second interface information is used for displaying the to-be-processed target interface in an interactive page corresponding to the second user permission. With the second interface information, a user having the second user permission is enabled to review the to-be-processed target interface, so as to complete functional and security review before the interface is published. Since the entire management process before publishing an interface is implemented in a manner based on an interactive operation and a visual interface, the standardizability of an interface description manner is improved, the difficulty and time consumption of user review are reduced, and automatic task advance is performed in conjunction with a workflow, thereby improving the efficiency of the entire interface management process.

In this embodiment, displaying first interface information in an interactive page corresponding to a first user permission, the first interface information indicating at least one to-be-processed interface, and the to-be-processed interface being an application programming interface processed based on the first user permission; configuring a to-be-processed target interface to be in a target state in response to a first operation instruction for the to-be-processed target interface, wherein the first operation instruction is realized based on the first user permission; and under a predetermined triggering condition, according to a target state of the to-be-processed target interface, publishing the to-be-processed target interface to an open platform, or generating second interface information corresponding to the to-be-processed target interface, the second interface information being used for displaying the to-be-processed target interface in an interactive page corresponding to a second user permission, by providing corresponding interactive interfaces for roles with different permissions in an interface publication process, and based on an interaction instruction input by a user to respectively process the interface, the visualization and standardization of a management process before publishing the interface are realized, the time consumption of the management process is shortened, and the interface management efficiency is improved.

FIG. 6 is a second schematic flowchart of a method for interactive publication of an interface based on a permission according to an embodiment of the present disclosure. On the basis of the embodiment shown in FIG. 2, this embodiment describes in detail the process of creating an new interface, and the method for interactive publication of an interface based on a permission comprises:

Step S201: displaying an interactive page corresponding to a first user permission, and obtaining an interface configuration parameter in response to a second operation instruction, the interface configuration parameter mapping a remote call service corresponding to the to-be-processed interface.

For example, the first user permission is, for example, a user permission of a development user. Similar to the embodiment shown in FIG. 2, by using login information input by a user, for example, a user name and a password, a corresponding interactive interface is logged in and displayed, i.e., an interactive interface corresponding to the first user permission. After that, the user inputs a second operation for creating a new interface, and the terminal device correspondingly generates a second operation instruction, wherein the second operation instruction comprises a specific trigger instruction for a control and a corresponding interface configuration parameter, such as an interface identifier and an interface category input by the user. The interface configuration parameter is used for mapping a remote call service (RPC service) corresponding to a to-be-processed interface, and more specifically, the interface configuration parameter comprises for example a remote procedure call name. By setting a corresponding remote procedure call name for a to-be-processed interface, the to-be-processed interface may be mapped to a corresponding RPC service.

Step S202: generating the first interface information based on the interface configuration parameter, wherein the first interface information indicates at least one to-be-processed interface, and the to-be-processed interface is an application programming interface processed based on a first user permission.

Specifically, generating the first interface information based on the interface configuration parameters includes:

One or more to-be-generated interfaces are configured based on the interface configuration parameters, and then first interface information is generated based on the configured one or more to-be-generated interfaces. For example, the interface configuration parameter comprises a first parameter, and the first parameter comprises at least one of: remote procedure call name, method name, business in parameter, internal variable in parameter, response out parameter, error code. The remote procedure call name is a name corresponding to an RPC service, and the method name is a name of a specific method called in the RPC service. By the remote procedure call name and the method name, an interface may be uniquely mapped to a functional function. The business input parameter, internal variable in parameter, response out parameter are an input parameter and an output parameter when a function corresponding to the remote procedure call name and method name is called, and the error code is an indication identifier when the function output is abnormal.

Further, for example, the interface configuration parameter further comprises a second parameter, and the second parameter is used for indicating the second user permission for processing the to-be-processed interface. For example, the second parameter may include: an API name, an API group, a responsible person, a function description, a use scenario description, an authorized account type, whether a setting is public, and the like. The second parameter may be considered as basic information about an interface. By the second parameter, the permission belonging of an API may be determined, and the second user permission, i.e., a permission level or a responsible person, of the to-be-generated interface is indicated (after being generated, the to-be-processed interface).

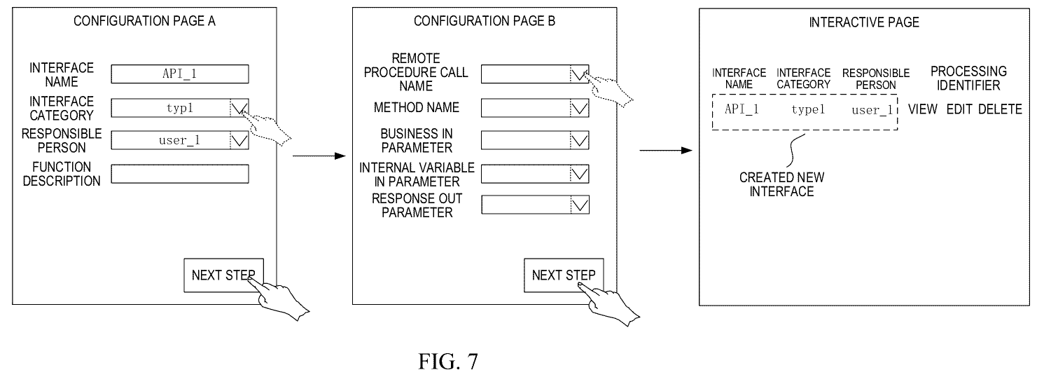

Further, the process of generating the first interface information based on the interface configuration parameters may be realized by a corresponding configuration page. FIG. 7 is a schematic diagram of generating first interface information through a configuration page according to an embodiment of the present disclosure. As shown in FIG. 7, the configuration page A is used for obtaining a second parameter input by the user, for example, including an interface name, an interface category, a responsible person, a function description, etc. The user may display the contents and items predetermined therein through a pull-down operation. After the user finishes filling in, the terminal device obtains a corresponding complete second reference, and then, based on the user's operation directed to “next step”, a configuration page B is displayed, wherein the configuration page B is used for obtaining a first parameter input by a user, for example, comprising a remote procedure call name, a method name, a business in parameter, an internal variable in parameter, a response out parameter, etc. More specifically, in the configuration page B, a corresponding sub-parameter may also be set for each first parameter, for example, a parameter type, a Boolean value indicating whether the parameter is necessary (not shown in the figure), and the like. Similarly, the user may display and select the predetermined content and item through a pull-down operation. After the foregoing configuration process is completed, a new interface is generated by continuing a corresponding completion instruction (which is shown as an operation of clicking “next step” in the figure). Meanwhile, first interface information indicating the created new interface is generated.

In this embodiment, because the process of creating a new interface is standardized, in the process of editing or reviewing the created new interface for a second time, the problems of long time consumption and low efficiency caused by modifying and reviewing in a code checking manner are avoided in combination with the visual manner.

Step S203: testing the to-be-processed interface corresponding to the first interface information to obtain a test result.

For example, after the to-be-processed interface is generated, in order to ensure the configuration of the to-be-processed interface is correct, the to-be-processed interface may be tested based on the configuration parameter corresponding to the to-be-processed interface obtained in the foregoing step.

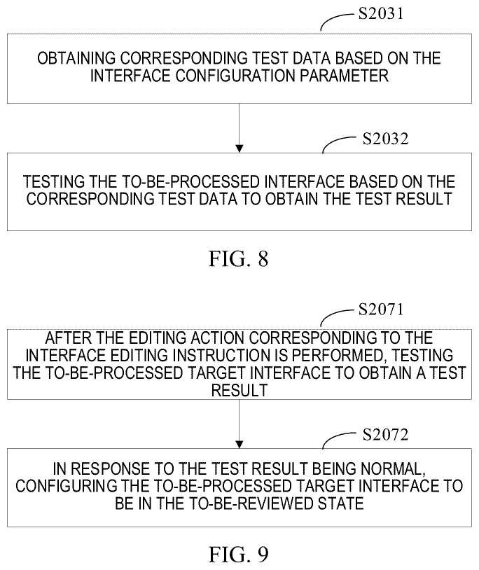

Optionally, as shown in FIG. 8, step S203 includes two specific steps of step S2031 and step S2032:

Step S2031: obtaining corresponding test data based on the interface configuration parameter.

Step 2032: testing the to-be-processed interface based on the corresponding test data to obtain the test result.

For example, the interface configuration parameter is an interface configuration parameter obtained through a second operation instruction in the foregoing step. Then, corresponding test data may be obtained for testing based on the interface configuration parameter of the to-be-processed interface. Specifically, the test mode for example directly use an online service. After an interface definition (interface name) is obtained, using a fixed application predetermined by an open platform and a test store identifier (Token), an in parameter is generated and API request is initialize, and the to-be-processed interface passes the test only returning a correct API, otherwise, not passed the test.

Step S204: displaying the test result on the interactive page.

Step S205: displaying the first interface information on the interactive page.

By displaying a test result, a user is informed whether a configuration error exists in a created new interface, thereby ensuring the implementation of an interface function and improving the security of the interface. Specifically, for example, in response to the test being passed, the test result is displayed at a predetermined position of the interactive interface, for example, “configuration is successful”; otherwise, in response to the test being not passed, the test result is displayed at a predetermined position of the interactive interface, for example, “configuration failed”.

Further, when or after the test result is completed, the first interface information is displayed in the interactive page, indicating the created new to-be-processed interface, and the specific implementation of displaying the first interface information is described in detail in the embodiment shown in FIG. 2, and is not repeated herein.

Optionally, the steps of this embodiment further comprise:

Step S206: in response to the interface editing instruction for the to-be-processed target interface, editing an interface configuration parameter of the to-be-processed target interface.

Step S207: after an editing action corresponding to the interface editing instruction is performed, configuring the to-be-processed target interface to be in a to-be-reviewed state.

For example, the interface editing instruction is an implementation of the first operation instruction, and the user edits the created to-be-processed interface. This process is a process of processing a to-be-processed target interface in the embodiment shown in FIG. 2, and details are not repeated herein.

Optionally, as shown in FIG. 9, step S207 includes two specific steps, S2071 and S2072:

Step S2071: after the editing action corresponding to the interface editing instruction is performed, testing the to-be-processed target interface to obtain a test result.

Step S2072: in response to the test result being normal, configuring the to-be-processed target interface to be in the to-be-reviewed state.

For example, after editing a to-be-processed target interface based on an interface editing instruction, there is still a possibility of an editing error. In order to ensure the correctness of the edited to-be-processed target interface, after an editing action corresponding to the interface editing instruction is executed, the to-be-processed target interface is tested, and after it is confirmed that the editing is correct according to a test result, the to-be-processed target interface is configured to be in a to-be-reviewed state. In this way, the accuracy and efficiency of the interface configuration process are improved, and the workload in the review process is retrieved. The test process is similar to the test process in step S203, and is not further described herein.

Step S208: under a predetermined triggering condition, generating second interface information corresponding to the to-be-processed target interface.

Further, after the to-be-processed target interface is configured to be in a to-be-reviewed state, according to a specific workflow, a corresponding auditor with a corresponding permission is required to subsequently review the interface, and under a predetermined trigger condition, for example, a manual trigger or a timed trigger, information for indicating the to-be-reviewed interface is generated, that is, second interface information. The second interface information, similar to the first interface information, is used to indicate one or more to-be-processed interfaces.

Step S209: obtaining a target user having the second user permission corresponding to the second interface information.

Step S210: pushing review task information to the target user, the review task information being used for prompting the target user to review the to-be-processed target interface.

For example, after the second interface information is generated, a mapping to the corresponding user permission is generated, where the mapping relationship may be determined based on a parameter, for example, an “responsible person” parameter, in the to-be-processed interface indicated by the second interface information. Therefore, based on the second interface information, the target user having the second user permission corresponding to the second interface information may be obtained. Further, the terminal device pushes the review task information to the target user through the interface management server, and prompts the target user to review the to-be-processed target interface. In one possible implementation, the specific implementation of pushing the review task information to the target user comprises pushing to a user end on which the target user logs in, so as to prompt the target user for review.

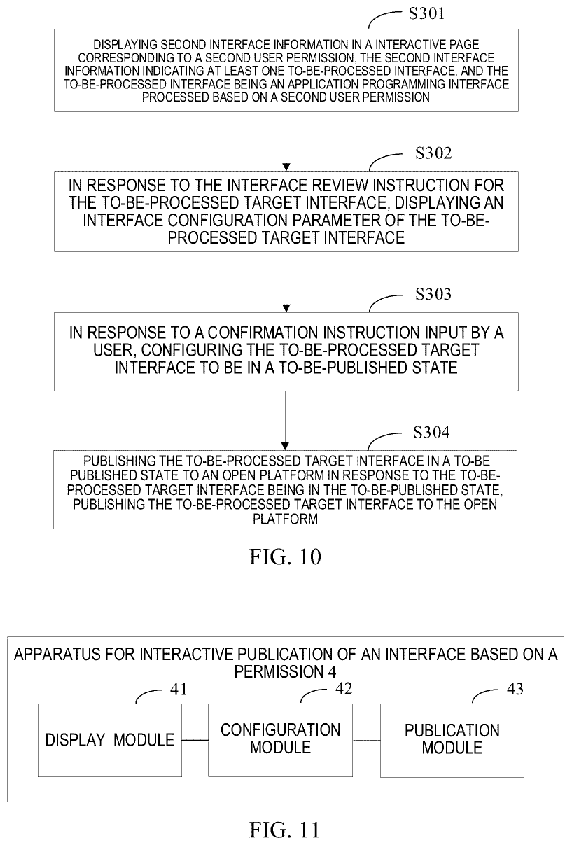

FIG. 10 is a third schematic flowchart of a method for interactive publication of an interface based on a permission according to an embodiment of the present disclosure. Based on the embodiment shown in FIG. 2, this embodiment describes in detail a process of reviewing an interface. The process may also be after the step of creating a new interface shown in FIG. 6. The method for interactive publication of an interface based on a permission includes:

Step S301: displaying second interface information in an interactive page corresponding to a second user permission, the second interface information indicating at least one to-be-processed interface, and the to-be-processed interface being an application programming interface processed based on a second user permission.

For example, the second user permission, for example, is a user permission of an auditor, and the second interface information is generated after the process of creating and editing an interface provided in the embodiment shown in FIG. 6, and is sent to (a task to be reviewed queue of) a target user corresponding to the second user permission through the interface management server. When the user logs in with the login information corresponding to the second user permission, the second interface information is displayed on the interactive interface, where the second interface information is the to-be-processed interface that needs to be reviewed. The second interface information may be displayed in a predetermined display area, and for details, reference may be made to the schematic diagram of an interactive interface shown in FIG. 4.

Step S302: in response to the interface review instruction for the to-be-processed target interface, displaying an interface configuration parameter of the to-be-processed target interface.

For example, the interface review instruction is an implementation of the first operation instruction, and the interface review instruction is implemented based on the corresponding second user permission, that is, only the target user having the second user permission can input the interface review instruction, to enable the terminal device to execute the steps of this embodiment. Further, in response to an interface reviewing instruction for a to-be-processed target interface, interface configuration parameters of the to-be-processed target interface are displayed, for example, basic parameters such as an API name, an API group, a responsible person, a function description, a usage scenario description, an authorization account type, setting whether to public, and calling parameters such as a remote procedure call name, a method name, a business in parameter, an internal variable in parameter, a response out parameter, and an error code. More specifically, the terminal device displays all the interface configuration parameters by a preview map, so that an auditor may rapidly review the interface configuration parameters, wherein when the interface configuration parameters of a to-be-processed target interface are displayed, the display is performed based on a fixed display rule, for example, displaying an parameter A, a parameter B, a parameter C, etc. from top to bottom. In this way, the difficulty of information retrieval by auditor is reduced, and the time consumption of reviewing is reduced.

Step S303: in response to a confirmation instruction input by a user, configuring the to-be-processed target interface to be in a to-be-published state.

Step S304: publishing the to-be-processed target interface in a to-be-published state to the open platform.

Further, after user reviewing, based on a confirmation instruction input by the user, the terminal device configures the to-be-processed target interface to be in a to-be-published state by the interface management server, and then, for example, based on a trigger instruction sent to the interface management server, the interface management server is controlled to publish all the to-be-processed target interfaces in the to-be-published state to the open platform, thereby completing the process of publishing the interfaces.

Further, the interactive page comprises a first sub-interface and/or a second sub-interface, the first sub-interface is configured to display a to-be-processed interface that is not currently published to the open platform; the second sub-interface is configured to display a to-be-processed interface that has been currently published to the open platform.

When the interface is published to the open platform, the interface will be marked as a published interface by the terminal device, and synchronized to the interface management server. Meanwhile, in the interactive page of the terminal device, the published interface is displayed in the second sub-interface, and the interface in the reviewed or modified state is displayed in the first sub-interface. In this way, fine management is implemented on the published interface and the unpublished interface, and the comprehensive management cost of the open interface is reduced.

In this embodiment, second interface information is displayed in an interactive page corresponding to a second user permission, so that an auditor may quickly obtain a to-be-reviewed interface, and quick review of the to-be-reviewed interface is completed in combination with a visual interface and a fixed display rule, thereby improving interface management and review efficiency in an interface publishing process and reducing time consumption.

Corresponding to the method for interactive publication of an interface based on a permission in the preceding embodiments, FIG. 11 is a structural block diagram of an apparatus for interactive publication of an interface based on a permission according to an embodiment of the present disclosure. For ease of description, only parts related to the embodiments of the present disclosure are shown. Referring to FIG. 11, the apparatus 4 for interactive publication of an interface based on a permission includes:
a display module 41 configured to display first interface information in an interactive page corresponding to a first user permission, the first interface information indicating at least one to-be-processed interface, and the to-be-processed interface being an application programming interface processed based on the first user permission;
a configuration module 42 configured to configure a to-be-processed target interface to be in a target state in response to a first operation instruction for the to-be-processed target interface, wherein the first operation instruction is realized based on the first user permission; and
a publication module 43 configured to, under a predetermined triggering condition, according to a target state of the to-be-processed target interface, publish the to-be-processed target interface to an open platform, or generate second interface information corresponding to the to-be-processed target interface, the second interface information being used for displaying the to-be-processed target interface in an interactive page corresponding to a second user permission.

In one embodiment of the present disclosure, the first operation instruction comprises an interface editing instruction, the configuration module 42 is specifically configured for: in response to the interface editing instruction for the to-be-processed target interface, editing an interface configuration parameter of the to-be-processed target interface; after an editing action corresponding to the interface editing instruction is performed, configuring the to-be-processed target interface to be in a to-be-reviewed state;

The publication module 43 is specifically configured for: in response to the to-be-processed target interface being in the to-be-reviewed state, generating the second interface information corresponding to the to-be-processed target interface.

In one embodiment of the present disclosure, after an editing action corresponding to the interface editing instruction is performed, configuring the to-be-processed target interface to be in a to-be-reviewed state, the configuration module 42 is specifically configured for: after the editing action corresponding to the interface editing instruction is performed, testing the to-be-processed target interface to obtain a test result; and in response to the test result being normal, configuring the to-be-processed target interface to be in the to-be-reviewed state.

In one embodiment of the present disclosure, the first operation instruction comprises an interface reviewing instruction, the configuration module 42 is specifically configured for: in response to the interface review instruction for the to-be-processed target interface, displaying an interface configuration parameter of the to-be-processed target interface; in response to a confirmation instruction input by a user, configuring the to-be-processed target interface to be in a to-be-published state; the publication module 43 is specifically configured for: in response to the to-be-processed target interface being in the to-be-published state, publishing the to-be-processed target interface to the open platform.

In one embodiment of the present disclosure, after generating the second interface information corresponding to the to-be-processed target interface, the publication module 43 is further configured for: obtaining a target user having the second user permission corresponding to the second interface information; and pushing review task information to the target user, the review task information being used for prompting the target user to review the to-be-processed target interface.

In one embodiment of the present disclosure, before displaying the first interface information, the configuration module 42 is further configured for: obtaining an interface configuration parameter in response to a second operation instruction, the interface configuration parameter mapping a remote call service corresponding to the to-be-processed interface; and generating the first interface information based on the interface configuration parameter.

In one embodiment of the present disclosure, the interface configuration parameter comprises a first parameter, and the first parameter comprises at least one of: remote procedure call name, method name, business in parameter, internal variable in parameter, response out parameter, error code.

In one embodiment of the present disclosure, the interface configuration parameter further comprises a second parameter, and the second parameter is used for indicating the second user permission for processing the to-be-processed interface.

In one embodiment of the present disclosure, after generating the first interface information, the configuration module 42 is further configured for: testing the to-be-processed interface corresponding to the first interface information to obtain a test result; and the display module 41 is further configured for displaying the test results on the interactive page.

In one embodiment of the present disclosure, the configuration module 42, when testing the to-be-processed interface corresponding to the first interface information to obtain a test result, is further configured for: obtaining corresponding test data based on the interface configuration parameter; and testing the to-be-processed interface based on the corresponding test data to obtain the test result.

In one embodiment of the present disclosure, the interactive page comprises a first sub-interface and/or a second sub-interface, the first sub-interface is configured to display a to-be-processed interface that is not currently published to the open platform; the second sub-interface is configured to display a to-be-processed interface that has been currently published to the open platform.

The display module 41, the configuration module 42, and the publication module 43 are connected in sequence. The apparatus 4 for interactive publication of an interface based on a permission provided in this embodiment may execute the technical solution of the preceding method embodiment. The implementation principle and technical effect are similar, and are not described again in this embodiment.

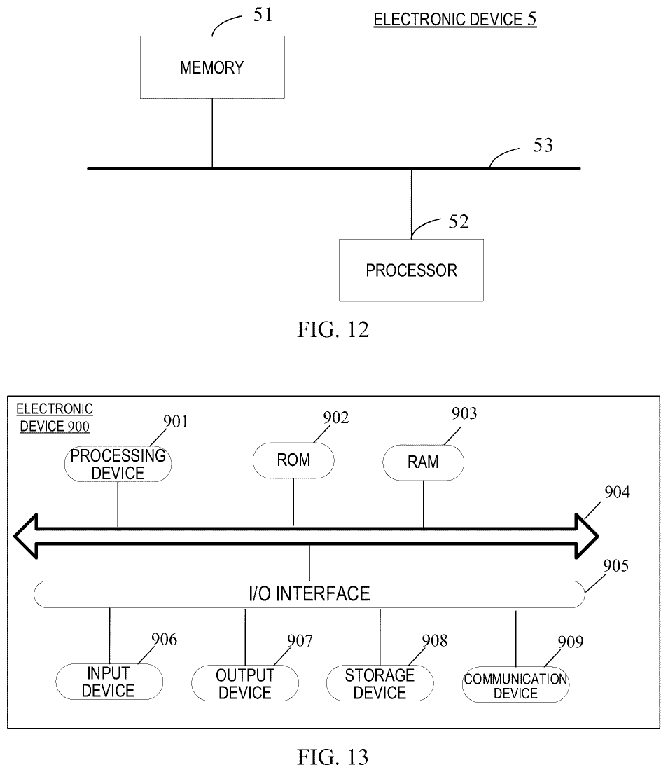

FIG. 12 is a schematic structural diagram of an electronic device according to an embodiment of the present disclosure. As shown in FIG. 12, the electronic device 5 includes:
a processor 51, and a memory 52 communicatively connected with the processor 51;
the memory 52 storing computer executable instructions which, when executed by the processor 51, implement the method for interactive publication of an interface based on a permission as shown in FIG. 2 to FIG. 10.

Optionally, the processor 51 and the memory 52 are connected through a bus 53.

The related descriptions can be understood with reference to the related descriptions and effects corresponding to the steps in the embodiments corresponding to FIG. 2 to FIG. 10, and are not repeated herein.

Referring to FIG. 3, it shows a schematic structural diagram of an electronic device 900 suitable for implementing embodiments of the present disclosure. The electronic device 900 may be a terminal device or a server. The terminal device may include, but is not limited to, a mobile terminal such as a mobile phone, a notebook computer, a digital broadcast receiver, a personal digital assistant (PDA), a portable android device (PAD), a portable multimedia player (PMP), a vehicle-mounted terminal (for example, a vehicle-mounted navigation terminal), and the like, and a fixed terminal such as a digital TV, a desktop computer, and the like. The electronic device shown in FIG. 13 is merely an example and should not bring any limitation to the functions and scope of use of the embodiments of the present disclosure.

As shown in FIG. 13 the electronic device 900 may include processing device (e.g., central processing unit, graphics processing unit, etc.) 901 that may perform various suitable actions and processes in accordance with a program stored in read only memory (ROM) 902 or a program loaded into random access memory (RAM) 903 from storage device 908. In the RAM 903, various programs and data necessary for the operation of the electronic device 900 are also stored. The processing device 901, the ROM 902, and the RAM 903 are connected to each other via a bus 904. An input/output (I/O) interface 905 is also connected to the bus 904.

In general, the following devices may be connected to the I/O interface 905: an input device 906 including, for example, a touch screen, a touch pad, a keyboard, a mouse, a camera, a microphone, an accelerometer, a gyroscope, or the like; an output device 907 including, for example, a liquid crystal display (LCD), a speaker, a vibrator, or the like; a storage device 908 including, for example, a magnetic tape, a hard disk, or the like; and a communication device 909. The communication device 509 may allow electronic device 900 to communicate wirelessly or wired with other devices to exchange data. While FIG. 9 illustrates an electronic device 900 with a variety of component, it should be understood that it is not required that all of the illustrated components be implemented or provided. More or fewer components may alternatively be implemented or provided.

In particular, the processes described above with reference to the flowcharts may be implemented as computer software programs in accordance with embodiments of the present disclosure. For example, embodiments of the present disclosure include a computer program product comprising a computer program carried on a non-transitory computer readable medium. The computer program comprises a program code for executing the method as shown in the flowchart. In such an embodiment, the computer program may be downloaded and installed from the network via communications device 909, or installed from storage device 908, or installed from ROM 902. When the computer program is executed by the processing device 901, the above-described functions defined in the method of embodiments of the present disclosure are executed.

It should be noted that the computer readable medium in the present disclosure may be a computer readable signal medium or a computer readable storage medium, or any combination thereof. A computer readable storage medium may be, for example, but not limited to, an electronic, magnetic, optical, electromagnetic, infrared, or semiconductor system, apparatus, or device, or any suitable combination of the foregoing. More specific examples of the computer readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain or store a program for use by or in connection with an instruction execution system, apparatus, or device. While in the present disclosure, a computer readable signal medium may include a propagated data signal with computer readable program code embodied therein, for example, in baseband or as part of a carrier wave. Such a propagated signal may take any of a variety of forms, including, but not limited to, electro-magnetic signal, optical signal, or any suitable combination thereof. A computer readable signal medium may also be any computer readable medium that is not a computer readable storage medium and that can send, propagate, or transport a program for use by or in connection with an instruction execution system, apparatus, or device.

Program code embodied on a computer readable medium may be transmitted using any appropriate medium, including, but not limited to, wireline, optical fiber cable, RF (radio frequency), etc., or any suitable combination of the foregoing.

The above computer readable medium may be included in the electronic device, or may exist separately and not be installed in the electronic device.

The above computer readable medium carries one or more programs. When the one or more programs are executed by the electronic device, the electronic device is enabled to execute the method of above embodiments.

Computer program code for carrying out operations of the present disclosure may be written in any combination of one or more programming languages, including an object oriented programming language such as Java, Smalltalk, C++ or the like and conventional procedural programming languages, such as the ‘C’ programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, a program segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart, and combinations of blocks in the block diagrams and/or flowchart, can be implemented by special purpose hardware-based systems that perform the specified functions or acts, or combinations of special purpose hardware and computer instructions.

The units involved in the embodiments of the present disclosure may be implemented through software or hardware. The name of a module does not constitute a limitation to the module itself in some cases, for example, the first acquisition unit may also be described as “unit to acquire at least two internet protocol addresses”.

The functions described herein above may be performed, at least in part, by one or more hardware logic components. For example, without limitation, exemplary types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), etc.

In the context of this disclosure, a machine-readable medium may be tangible media that may contain or store a program for use by or in connection with an instruction execution system, apparatus, or device.

The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of machine-readable storage media include an electrical connection based on one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination of the foregoing.

In a first aspect, according to one or more embodiments of this disclosure, a method for interactive publication of an interface based on a permission is provided, comprising:
displaying first interface information in an interactive page corresponding to a first user permission, the first interface information indicating at least one to-be-processed interface, and the to-be-processed interface being an application programming interface processed based on the first user permission; configuring a to-be-processed target interface to be in a target state in response to a first operation instruction for the to-be-processed target interface, wherein the first operation instruction is realized based on the first user permission; and under a predetermined triggering condition, according to a target state of the to-be-processed target interface, publishing the to-be-processed target interface to an open platform, or generating second interface information corresponding to the to-be-processed target interface, the second interface information being used for displaying the to-be-processed target interface in an interactive page corresponding to a second user permission.

According to one or more embodiments of this disclosure, the first operation instruction comprises an interface editing instruction, the configuring a to-be-processed target interface to be in a target state in response to a first operation instruction for the to-be-processed target interface comprises: in response to the interface editing instruction for the to-be-processed target interface, editing an interface configuration parameter of the to-be-processed target interface; after an editing action corresponding to the interface editing instruction is performed, configuring the to-be-processed target interface to be in a to-be-reviewed state; the under a predetermined triggering condition, according to a target state of the to-be-processed target interface, generating second interface information corresponding to the to-be-processed target interface, comprises: in response to the to-be-processed target interface being in the to-be-reviewed state, generating the second interface information corresponding to the to-be-processed target interface.

According to one or more embodiments of this disclosure, the after an editing action corresponding to the interface editing instruction is performed, configuring the to-be-processed target interface to be in a to-be-reviewed state comprises: after the editing action corresponding to the interface editing instruction is performed, testing the to-be-processed target interface to obtain a test result; and in response to the test result being normal, configuring the to-be-processed target interface to be in the to-be-reviewed state.

According to one or more embodiments of this disclosure, the first operation instruction comprises an interface reviewing instruction, the configuring a to-be-processed target interface to be in a target state in response to a first operation instruction for the to-be-processed target interface comprises: in response to the interface review instruction for the to-be-processed target interface, displaying an interface configuration parameter of the to-be-processed target interface; in response to a confirmation instruction input by a user, configuring the to-be-processed target interface to be in a to-be-published state; the under a predetermined triggering condition, according to a target state of the to-be-processed target interface, publishing the to-be-processed target interface to an open platform comprises: in response to the to-be-processed target interface being in the to-be-published state, publishing the to-be-processed target interface to the open platform.

According to one or more embodiments of this disclosure, after generating the second interface information corresponding to the to-be-processed target interface, the method further comprises: obtaining a target user having the second user permission corresponding to the second interface information; and pushing review task information to the target user, the review task information being used for prompting the target user to review the to-be-processed target interface.

According to one or more embodiments of this disclosure, the method further comprises: before displaying the first interface information, obtaining an interface configuration parameter in response to a second operation instruction, the interface configuration parameter mapping a remote call service corresponding to the to-be-processed interface; and generating the first interface information based on the interface configuration parameter.

According to one or more embodiments of this disclosure, the interface configuration parameter comprises a first parameter, and the first parameter comprises at least one of: remote procedure call name, method name, business in parameter, internal variable in parameter, response out parameter, error code.

According to one or more embodiments of this disclosure, the interface configuration parameter further comprises a second parameter, and the second parameter is used for indicating the second user permission for processing the to-be-processed interface.

According to one or more embodiments of this disclosure, the method further comprises: after generating the first interface information, testing the to-be-processed interface corresponding to the first interface information to obtain a test result; and displaying the test results on the interactive page.

According to one or more embodiments of this disclosure, the testing the to-be-processed interface corresponding to the first interface information to obtain a test result comprises: obtaining corresponding test data based on the interface configuration parameter; and testing the to-be-processed interface based on the corresponding test data to obtain the test result.

According to one or more embodiments of this disclosure, the interactive page comprises a first sub-interface and/or a second sub-interface, the first sub-interface is configured to display a to-be-processed interface that is not currently published to the open platform; the second sub-interface is configured to display a to-be-processed interface that has been currently published to the open platform.

In a second aspect, according to one or more embodiments of this disclosure, an apparatus for interactive publication of an interface based on a permission is provided, comprising:
a display module configured to display first interface information in an interactive page corresponding to a first user permission, the first interface information indicating at least one to-be-processed interface, and the to-be-processed interface being an application programming interface processed based on the first user permission;
a configuration module configured to configure a to-be-processed target interface to be in a target state in response to a first operation instruction for the to-be-processed target interface, wherein the first operation instruction is realized based on the first user permission; and
a publication module configured to, under a predetermined triggering condition, according to a target state of the to-be-processed target interface, publish the to-be-processed target interface to an open platform, or generate second interface information corresponding to the to-be-processed target interface, the second interface information being used for displaying the to-be-processed target interface in an interactive page corresponding to a second user permission.

According to one or more embodiments of this disclosure, the first operation instruction comprises an interface editing instruction, the configuration module is specifically configured for: in response to the interface editing instruction for the to-be-processed target interface, editing an interface configuration parameter of the to-be-processed target interface; after an editing action corresponding to the interface editing instruction is performed, configuring the to-be-processed target interface to be in a to-be-reviewed state; the publication module is specifically configured for: in response to the to-be-processed target interface being in the to-be-reviewed state, generating the second interface information corresponding to the to-be-processed target interface.

According to one or more embodiments of this disclosure, after an editing action corresponding to the interface editing instruction is performed, configuring the to-be-processed target interface to be in a to-be-reviewed state, the configuration module is specifically configured for: after the editing action corresponding to the interface editing instruction is performed, testing the to-be-processed target interface to obtain a test result; and in response to the test result being normal, configuring the to-be-processed target interface to be in the to-be-reviewed state.

According to one or more embodiments of this disclosure, the first operation instruction comprises an interface reviewing instruction, the configuration module is specifically configured for: in response to the interface review instruction for the to-be-processed target interface, displaying an interface configuration parameter of the to-be-processed target interface; in response to a confirmation instruction input by a user, configuring the to-be-processed target interface to be in a to-be-published state; the publication module 43 is specifically configured for: in response to the to-be-processed target interface being in the to-be-published state, publishing the to-be-processed target interface to the open platform.

According to one or more embodiments of this disclosure, after generating the second interface information corresponding to the to-be-processed target interface, the publication module is further configured for: obtaining a target user having the second user permission corresponding to the second interface information; and pushing review task information to the target user, the review task information being used for prompting the target user to review the to-be-processed target interface.

According to one or more embodiments of this disclosure, before displaying the first interface information, the configuration module is further configured for: obtaining an interface configuration parameter in response to a second operation instruction, the interface configuration parameter mapping a remote call service corresponding to the to-be-processed interface; and generating the first interface information based on the interface configuration parameter.

According to one or more embodiments of this disclosure, the interface configuration parameter comprises a first parameter, and the first parameter comprises at least one of: remote procedure call name, method name, business in parameter, internal variable in parameter, response out parameter, error code.

According to one or more embodiments of this disclosure, the interface configuration parameter further comprises a second parameter, and the second parameter is used for indicating the second user permission for processing the to-be-processed interface.

According to one or more embodiments of this disclosure, after generating the first interface information, the configuration module is further configured for: testing the to-be-processed interface corresponding to the first interface information to obtain a test result; and the display module is further configured for displaying the test results on the interactive page.

According to one or more embodiments of this disclosure, the configuration module, when testing the to-be-processed interface corresponding to the first interface information to obtain a test result, is further configured for: obtaining corresponding test data based on the interface configuration parameter; and testing the to-be-processed interface based on the corresponding test data to obtain the test result.

According to one or more embodiments of this disclosure, the interactive page comprises a first sub-interface and/or a second sub-interface, the first sub-interface is configured to display a to-be-processed interface that is not currently published to the open platform; the second sub-interface is configured to display a to-be-processed interface that has been currently published to the open platform.

In a third aspect, according to one or more embodiments of this disclosure, an electronic device is provided, comprising: a processor, and a memory communicatively connected with the processor;

the memory storing computer executable instructions which, when executed by the processor, implement the method for interactive publication of an interface based on a permission of the first aspect and its various possible designs.

In a fourth aspect, according to one or more embodiments of this disclosure, a computer readable storage medium is provided, wherein the computer readable storage medium stores computer executable instructions which, when executed by a processor, implement the method for interactive publication of an interface based on a permission of the first aspect and its various possible designs.

In a fifth aspect, according to one or more embodiments of this disclosure, a computer program product comprising a computer program is provided, the computer program, when executed by a processor, implements the method for interactive publication of an interface based on a permission of the first aspect and its various possible designs.

In a sixth aspect, according to one or more embodiments of this disclosure, a computer program is provided, when executed by a processor, implementing the method for interactive publication of an interface based on a permission of the first aspect and its various possible designs.

The foregoing description is merely illustrative of the preferred embodiments of the present disclosure and of the technical principles applied thereto. As will be appreciated by those skilled in the art, the disclosure of the present disclosure is not limited to the technical solution formed by the specific combination of the described technical features, it should also cover other technical solutions formed by any combination of the described technical features or equivalent features thereof without departing from the described disclosed concept. For example, the above features and technical features having similar functions disclosed in the present disclosure (but not limited thereto) are replaced with each other to form a technical solution.

In addition, while operations are depicted in a particular order, this should not be understood as requiring that the operations be performed in the particular order shown or in sequential order. Multitasking and parallel processing may be advantageous in certain circumstances. Likewise, while several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or methodological acts, it is to be understood that the subject matter defined in the appended claims is not necessarily limited to the specific features or acts described above. Rather, the specific features and acts described above are merely example forms of implementing the claims.

1. A method for interactive publication of an interface based on a permission, comprising:
displaying first interface information in an interactive page corresponding to a first user permission, the first interface information indicating at least one to-be-processed interface, and the to-be-processed interface being an application programming interface processed based on the first user permission;
configuring a to-be-processed target interface to be in a target state in response to a first operation instruction for the to-be-processed target interface, wherein the first operation instruction is realized based on the first user permission; and
under a predetermined triggering condition, according to a target state of the to-be-processed target interface, publishing the to-be-processed target interface to an open platform, or generating second interface information corresponding to the to-be-processed target interface, the second interface information being used for displaying the to-be-processed target interface in an interactive page corresponding to a second user permission.

2. The method of claim 1, wherein the first operation instruction comprises an interface editing instruction,
the configuring a to-be-processed target interface to be in a target state in response to a first operation instruction for the to-be-processed target interface comprises:
in response to the interface editing instruction for the to-be-processed target interface, editing an interface configuration parameter of the to-be-processed target interface;
after an editing action corresponding to the interface editing instruction is performed, configuring the to-be-processed target interface to be in a to-be-reviewed state;
the under a predetermined triggering condition, according to a target state of the to-be-processed target interface, generating second interface information corresponding to the to-be-processed target interface, comprises:
in response to the to-be-processed target interface being in the to-be-reviewed state, generating the second interface information corresponding to the to-be-processed target interface.

3. The method of claim 2, wherein the after an editing action corresponding to the interface editing instruction is performed, configuring the to-be-processed target interface to be in a to-be-reviewed state comprises:
after the editing action corresponding to the interface editing instruction is performed, testing the to-be-processed target interface to obtain a test result; and
in response to the test result being normal, configuring the to-be-processed target interface to be in the to-be-reviewed state.

4. The method of claim 1, wherein the first operation instruction comprises an interface reviewing instruction, the configuring a to-be-processed target interface to be in a target state in response to a first operation instruction for the to-be-processed target interface comprises:
in response to the interface review instruction for the to-be-processed target interface, displaying an interface configuration parameter of the to-be-processed target interface;
in response to a confirmation instruction input by a user, configuring the to-be-processed target interface to be in a to-be-published state;
the under a predetermined triggering condition, according to a target state of the to-be-processed target interface, publishing the to-be-processed target interface to an open platform comprises:
in response to the to-be-processed target interface being in the to-be-published state, publishing the to-be-processed target interface to the open platform.

5. The method of claim 1, further comprising: after generating the second interface information corresponding to the to-be-processed target interface, obtaining a target user having the second user permission corresponding to the second interface information; and
pushing review task information to the target user, the review task information being used for prompting the target user to review the to-be-processed target interface.

6. The method of claim 1, wherein the method further comprises: before displaying the first interface information,
obtaining an interface configuration parameter in response to a second operation instruction, the interface configuration parameter mapping a remote call service corresponding to the to-be-processed interface; and
generating the first interface information based on the interface configuration parameter.

7. The method of claim 6, wherein the interface configuration parameter comprises a first parameter, and the first parameter comprises at least one of:
remote procedure call name, method name, business in parameter, internal variable in parameter, response out parameter, error code.

8. The method of claim 7, wherein the interface configuration parameter further comprises a second parameter, and the second parameter is used for indicating the second user permission for processing the to-be-processed interface.

9. The method of claim 6, wherein the method further comprises: after generating the first interface information,
testing the to-be-processed interface corresponding to the first interface information to obtain a test result; and
displaying the test results on the interactive page.

10. The method of claim 9, wherein the testing the to-be-processed interface corresponding to the first interface information to obtain a test result comprises:
obtaining corresponding test data based on the interface configuration parameter; and
testing the to-be-processed interface based on the corresponding test data to obtain the test result.

11. The method of claim 1, wherein the interactive page comprises a first sub-interface and/or a second sub-interface, the first sub-interface is configured to display a to-be-processed interface that is not currently published to the open platform; the second sub-interface is configured to display a to-be-processed interface that has been currently published to the open platform.

12. (canceled)

13. An electronic device, comprising: a processor, and a memory communicatively connected with the processor; the memory storing computer executable instructions which, when executed by the processor, implement the acts comprising:
displaying first interface information in an interactive page corresponding to a first user permission, the first interface information indicating at least one to-be-processed interface, and the to-be-processed interface being an application programming interface processed based on the first user permission;
configuring a to-be-processed target interface to be in a target state in response to a first operation instruction for the to-be-processed target interface, wherein the first operation instruction is realized based on the first user permission; and
under a predetermined triggering condition, according to a target state of the to-be-processed target interface, publishing the to-be-processed target interface to an open platform, or generating second interface information corresponding to the to-be-processed target interface, the second interface information being used for displaying the to-be-processed target interface in an interactive page corresponding to a second user permission.

14. A non-transitory computer readable storage medium, wherein the computer readable storage medium stores computer executable instructions which, when executed by a processor, implement the method for interactive publication of an interface comprising
displaying first interface information in an interactive page corresponding to a first user permission, the first interface information indicating at least one to-be-processed interface, and the to-be-processed interface being an application programming interface processed based on the first user permission;
configuring a to-be-processed target interface to be in a target state in response to a first operation instruction for the to-be-processed target interface, wherein the first operation instruction is realized based on the first user permission; and
under a predetermined triggering condition, according to a target state of the to-be-processed target interface, publishing the to-be-processed target interface to an open platform, or generating second interface information corresponding to the to-be-processed target interface, the second interface information being used for displaying the to-be-processed target interface in an interactive page corresponding to a second user permission.

15. (canceled)

16. (canceled)

17. The electronic device of claim 13, wherein the first operation instruction comprises an interface editing instruction,
the configuring a to-be-processed target interface to be in a target state in response to a first operation instruction for the to-be-processed target interface comprises:
in response to the interface editing instruction for the to-be-processed target interface, editing an interface configuration parameter of the to-be-processed target interface;
after an editing action corresponding to the interface editing instruction is performed, configuring the to-be-processed target interface to be in a to-be-reviewed state;
the under a predetermined triggering condition, according to a target state of the to-be-processed target interface, generating second interface information corresponding to the to-be-processed target interface, comprises:
in response to the to-be-processed target interface being in the to-be-reviewed state, generating the second interface information corresponding to the to-be-processed target interface.

18. The electronic device of claim 17, wherein the after an editing action corresponding to the interface editing instruction is performed, configuring the to-be-processed target interface to be in a to-be-reviewed state comprises:
after the editing action corresponding to the interface editing instruction is performed, testing the to-be-processed target interface to obtain a test result; and
in response to the test result being normal, configuring the to-be-processed target interface to be in the to-be-reviewed state.

19. The electronic device of claim 13, wherein the first operation instruction comprises an interface reviewing instruction, the configuring a to-be-processed target interface to be in a target state in response to a first operation instruction for the to-be-processed target interface comprises:
in response to the interface review instruction for the to-be-processed target interface, displaying an interface configuration parameter of the to-be-processed target interface;
in response to a confirmation instruction input by a user, configuring the to-be-processed target interface to be in a to-be-published state;
the under a predetermined triggering condition, according to a target state of the to-be-processed target interface, publishing the to-be-processed target interface to an open platform comprises:
in response to the to-be-processed target interface being in the to-be-published state, publishing the to-be-processed target interface to the open platform.

20. The electronic device of claim 13, the acts further comprising: after generating the second interface information corresponding to the to-be-processed target interface,
obtaining a target user having the second user permission corresponding to the second interface information; and
pushing review task information to the target user, the review task information being used for prompting the target user to review the to-be-processed target interface.

21. The electronic device of claim 13, wherein the acts further comprises: before displaying the first interface information,
obtaining an interface configuration parameter in response to a second operation instruction, the interface configuration parameter mapping a remote call service corresponding to the to-be-processed interface; and
generating the first interface information based on the interface configuration parameter.

22. The electronic device of claim 21, wherein the interface configuration parameter comprises a first parameter, and the first parameter comprises at least one of:
remote procedure call name, method name, business in parameter, internal variable in parameter, response out parameter, error code.

23. The electronic device of claim 18, wherein the interface configuration parameter further comprises a second parameter, and the second parameter is used for indicating the second user permission for processing the to-be-processed interface.
